(19) United States
(12) Patent Application Publication
(10) Pub. No.: US 2012/0001502 A1
(43) Pub. Date: Jan. 5, 2012

(54) Multi-unit Modular Stackable Switched Reluctance Motor System with Parallely Excited Low Reluctance Circumferential Magnetic Flux loops for High Torque Density Generation

(76) Inventors: Yee-Chun Lee, San Jose, CA (US); Chung Ching Yang, Saratoga, CA (US)

(21) Appl. No.: 13/174,551

(22) Filed: Jun. 30, 2011

Related U.S. Application Data
(60) Provisional application No. 61/360,681, filed on Jul. 1, 2010.

(51) Int. Cl. H02K 37/08

(52) U.S. Cl. 310/49.42

(57) ABSTRACT

The present invention is a apparatus of multi-unit modular stackable switched reluctance motor system with parallely excited low reluctance circumferential magnetic flux loops for high torque density generation. For maximized benefits and advanced motor features, the present invention takes full combined advantages of both SRM architecture and “Axial Flux” architecture by applying “Axial Flux” architecture into SRM design without using any permanent magnet, by modularizing and stacking the “Axial Flux” SRM design for easy configuration and customization to satisfy various drive torque requirements and broad applications, and by incorporating an en energy recovery transformer for minimizing switching circuitry thus further lowering the cost and further increasing the reliability and robustness. Unlike prior arts, the present invention does not use any permanent magnet and this “Axial Flux” SRM system is modularized and stackable with many benefits.

### CROSS REFERENCE TO RELATED APPLICATIONS

This application is based upon and claims the priority of a previously filed provisional patent application entitled “A Modular Multi-cell Stackable Switched Reluctance Motor with Parallely Excited Low Reluctance Circumferential Magnetic Flux loops for High Torque Density Generation” by Lee et al with application No. 61/360,681, filing date Jul. 1, 2010 and attorney docket number Lufa100 whose content is herein incorporated by reference for all purposes.

### FIELD OF INVENTION

The present invention relates generally to the field of switched reluctance motors constructions. More specifically, the present invention is directed to techniques and associated motor designs capable of generating high torque density with simplicity and low cost.

### BACKGROUND OF THE INVENTION

The switched reluctance motors (SRM), for variable speed and torque applications, have many advantages including mechanical simplicity (the simplest amongst all electric motors), low cost, high robustness and reliability, superior torque and power outputs per unit volume or per unit mass (torque density). These good attributes are due to the absence of armature winding, permanent magnets and commutated brushes in the rotor. The SRM can offer high level of performance, such as torque and power, over a range of rotation speeds. However, the drive electronics could be complex when operation employs multiphase excitation of stator groups. For broad applications, cost on the essential electronic components needs to be sufficiently reasonable.

Prior arts on various SRM are fundamentally based on the traditional “Radial Flux” excitation architecture. In such architecture the magnetic flux that between two complementary stator poles passes a long path through the center of rotation resulting in a large reluctance. The much shorter flux path “Axial Flux” architecture that has been adopted in many permanent-magnetic motors' disclosed in U.S. Pat. No. 6,922,004 and U.S. Pat. No. 7,394,228, but seems to be absent in the existing SRM literature.

FIG. 1 illustrates a prior art of a 6-stator 0103 and 4-rotor 0109 radial flux SRM with winding 0104. The path for the magnetic flux, through the center of rotation, is rather long that results in a large reluctance. The 3-phase drive voltage supplied by the drive electronics must meet a certain timing requirement shown in the timing diagram.

However, regardless of these prior arts just described there remains a need for motors with high torque density, high performance, high reliability and robustness, low cost, high manufacturability, and easy inventory management.

### SUMMARY OF THE INVENTION

Under a variety of embodiments, the present invention is a multi-unit modular stackable motor system (MUMMS) apparatus to generate rotation with high torque density in controllable speed and controllable torque and it has advantages including mechanical simplicity (the simplest amongst all electric motors), low cost, high robustness and reliability, superior torque and power outputs per unit volume or per unit mass (torque density). These good attributes are due to the absence of armature winding, permanent magnets and commutated brushes in the rotor. The SRM can offer high level of performance, such as torque and power, over a range of rotation speeds. However, the drive electronics could be complex when operation employs multiphase excitation of stator groups. For broad applications, cost on the essential electronic components needs to be sufficiently reasonable. The MUMMS includes a rotor shaft with a shaft core with a first shaft end and a second shaft end and an N-module motor system (NMMS) having a set of multiple independent SRM modules stacked together, i.e., stacked switched reluctance motor modules (SSRMⱼ where j>=1) are locked to the rotor shaft along the rotor shaft and coaxially coupled to the rotor shaft using the rotor shaft as its rotation center axis and producing a total output torque that is the sum total of those produced by each SSRMⱼ. More precisely expressed in a composite Cartesian and polar coordinate system r-θ-Z, the MUMMS rotational plane is in parallel to the X-Y plane and the r-θ plane.

In a specific embodiment, for rotatably supporting the rotor shaft core, an NMMS includes a first end stator unit (FESU) located upon the first end of the rotor shaft, a second end stator unit (SESU) located upon the second end of the rotor shaft, and an intervening set of sequentially and mechanically locked rotor disk unit-1 (RDU₁), inner stator unit insert-1 (ISUI₁), rotor disk unit-2 (RDU₂), inner stator unit insert-2 (ISUI₂), . . . , rotor disk unit-j (RDUⱼ), inner stator unit insert-j (ISUIⱼ), . . . , rotor disk unit-N−1 (RDU_{N-1}), inner stator unit insert-N−1 (ISUI_{N-1}) and rotor disk unit-N (RDU_{N}), located upon the shaft core between the FESU and the SESU, for mechanically coupling the FESU to the SESU, where each ISUIⱼ has a central bearing-j (CBⱼ) for rotatably supporting the shaft core there through and each RDUⱼ has an integral central sleeve shaft-j (CSSⱼ) locked upon the shaft core. Each RDUⱼ and its two neighboring stator units respectively includes a non-ferro magnetic rotor pole structure (RPSⱼ) and two magnetically energizable stator pole structures (SPSⱼ₋₁) and (SPSⱼ) confronting yet separated from the RPSⱼ by at least two air gaps (AGⱼ₋₁) & (AGⱼ) thus forming the SSRMⱼ.

In a more specific embodiment, the shaft core has an adjustable shaft locking means and, correspondingly, each CSSⱼ has an adjustable sleeve locking means for mating then locking each CSSⱼ upon the adjustable shaft locking means with an adjustable relative angle (θ) offset there between.

In another more specific embodiment, each RPSⱼ has a set of circumferential rotor pole elements (CRPEⱼₖ, k=1,2, . . . , P where P>1) located near the RDUⱼ periphery and further distributed along θ-direction according to a first set of pre-determined θ-coordinates. Correspondingly, each SPSⱼ has a set of circumferential stator pole elements (CSPEⱼₘ, m=1,2, . . . , Q where Q>1) located near the RDUⱼ periphery, further distributed along θ-direction according to a second set of pre-determined θ-coordinates and each CSPEⱼₘ has a stator pole coil set (SPCSⱼₘ) having stator coil interconnecting terminals (SCITⱼₘ) and wound upon said CSPEⱼₘ upon powering of each SPCSⱼₘ with a stator coil current (SCCⱼₘ) via the SCITⱼₘ with a phase according to the relative θ-coordinate between the RDUⱼ and its two neighboring stator units. Corresponding to each CRPEⱼₖ a local, short-path thus low reluctance circumferential magnetic flux field (CMFFⱼₖ) with low magnetic loss can be successfully excited by the powered SPCSⱼₘ while said each CRPEⱼₖ passing through each of the CSPEⱼₘ thus producing a high component switched reluctance torque (SRTQⱼₖ). And the SSRMⱼ produces a switched reluctance torque (SRTQⱼ) equal to SRTQⱼ₁+SRTQⱼ₂+ . . . +SRTQ_{jP}.

In a more specific embodiment, the MUMMS includes, in an Axial Flux architecture, the complimentary stator pole pair are arranged along the periphery of rotation. The two opposing stator poles are separated by the thickness of the rotor disk plus two stator-to-rotor pole gaps (as illustrated in FIG. 8), a similar Axial Flux SRM design. This type of Axial Flux configuration represents the shortest achievable magnetic flux path.

In a more specific embodiment, the first set of pre-determined-coordinates are evenly distributed around a whole circle and the second set of pre-determined-coordinates are evenly distributed around a whole circle as well.

In another more specific embodiment, each CRPEⱼₖ includes two opposite elemental rotor pole faces (ERPFⱼₖ₁ and ERPFⱼₖ₂) both oriented perpendicular to Z-axis. And correspondingly, each CSPEⱼₘ of ISUIⱼ includes two opposing elemental stator pole faces (ESPFⱼₘ₁ and ESPFⱼₘ₂) both oriented perpendicular to Z-axis and, upon rotation of the RDUⱼ, successively surrounding each of the pair (ERPFⱼₖ₁, ERPFⱼₖ₂). By separating from it by two elemental air gaps EAGⱼ₁ and EAGⱼ₂ such that, under conditions of otherwise equal air gap flux density, rotor pole face area, stator pole face area and distance between air gap and the z-axis, the produced component SRTQⱼₖ is about twice as that produced by another system with a single elemental air gap.

In a further specific embodiment, the SPCS_{j,m}, SPCS_{j,m+1} of each neighboring pair (CSPE_{j,m}, CSPE_{j,m+1}) along θ-coordinate are wound with coordinated direction. By powering either one of SPCS_{j,m}, SPCS_{j,m+1} with a stator coil current, the so excited circumferential magnetic flux field has a single-loop pattern that:
a) has its primary plane oriented perpendicular to r-direction;
b) threads through two peripheral flux return yokes (PFRY_{j,m1}, PFRY_{j,m2}) respectively of the ISUIⱼ₋₁ and the ISUIⱼ; and
c) also sequentially threads through the (ESPF_{j,m1},ESPF_{j,m2},ESPF_{j,m+12},ESPF_{j,m+11}).

In a further specific embodiment, the pair of PFRY_{j,m1}, PFRY_{j,m2} has at least one closed-loop energy transfer coil (CLETCⱼₘ) wound. Then following a switching off of SCCⱼₘ but before a switching on of SCCⱼₘ₊₁ the magnetic energy stored in the circumferential magnetic flux field gets absorbed by a correspondingly generated current through the CLETCⱼₘ counter balancing out an otherwise would be generated detrimental electromagnetic motive force (EMF) across the SPCS_{j,m}. And upon a later switching on of SCCⱼₘ₊₁ its stator coil current build up would cause a corresponding transfer of the previously absorbed energy from the CLETCⱼₘ to the SCCⱼₘ₊₁. Comparing with a traditional system without the closed-loop energy transfer coil but having to use two external drive transistors per stator pole coil set, the MUMMS advantageously requires only one external drive transistor per stator pole coil set.

In another more specific embodiment, the SPCS_{j,m}, SPCS_{j,m+1} of each neighboring pair (CSPE_{j,m}, CSPE_{j,m+1}) along-coordinate are wound with coordinated direction and further connected in series or parallel. Then by their powering with SCCⱼₘ and SCCⱼₘ₊₁, the so excited CMFFⱼₘ has two tangentially reinforcing sub-loops:
a) both having its primary plane oriented perpendicular to r-direction;
b) respectively threading through two peripheral flux return yokes (PFRY_{j,m1}, PFRY_{j,m2}) respectively of the ISUIⱼ₋₁ and the ISUIⱼ; and
c) also respectively threading through the (ESPF_{j,m1},ESPF_{j,m+11}) and the (ESPF_{j,m2},ESPF_{j,m+12}).

In a further specific embodiment, the PFRY_{j,m1} and PFRY_{j,m2} respectively includes a closed-loop energy transfer coil CLETC_{j,m} and a CLETC_{j-1,m} wound. Then following a switching off of SCCⱼₘ but before a switching on of SCC_{j,m+1} the magnetic energy stored in the circumferential magnetic flux field gets absorbed by two correspondingly generated current through CLETC_{j,m} and CLETC_{j-1,m}. This counter balances out two otherwise would be generated detrimental electromagnetic motive forces (EMF) respectively across the SPCS_{j,m} and the SPCS_{j-1,m}. And upon a later switching on of SCC_{j,m+1} its stator coil current build up would cause a corresponding transfer of the previously absorbed energy from the CLETC_{j,m} and the CLETC_{j-1,m} to the SCC_{j,m+1}. Thus, comparing with a traditional system without the closed-loop energy transfer coil but having to use two external drive transistors per stator pole coil set, the MUMMS advantageously requires only one external drive transistor per stator pole coil set.

In another specific embodiment, each CRPEⱼₖ includes two opposite elemental rotor pole faces (ERPFⱼₖ₁ and ERPFⱼₖ₂) both oriented perpendicular to r-direction. And correspondingly, each CSPEⱼₘ includes two opposing elemental stator dipole faces (ESPFⱼₘ₁ and ESPFⱼₘ₂) both oriented perpendicular to r-direction. And, upon rotation of the RDUⱼ, successively surrounding each of the pair (ERPFⱼₖ₁, ERPFⱼₖ₂) while separating from it by two elemental air gaps EAGⱼ₁ and EAGⱼ₂ then, under conditions of otherwise equal air gap flux density, rotor pole face area, stator pole face area and distance between air gap and the z-axis, the produced component SRTQⱼₖ is about twice as that produced by another system with a single elemental air gap.

In another more specific embodiment, each RPSⱼ further includes a set of inner circumferential rotor pole elements (ICRPEⱼₙ, n=1,2, . . . , R where R>1). They are arranged concentric with but located closer to the rotor shaft with respect to the set of CRPEⱼₖ. And they are further distributed along θ-direction according to a third set of pre-determined θ-coordinates. Correspondingly, each SPSⱼ includes a set of inner circumferential stator pole elements (ICSPEⱼₒ, o=1,2, . . . , S where S>1). They are arranged concentric with but located closer to the rotor shaft with respect to the set of CSPEⱼₘ. And they are further distributed along θ-direction according to a fourth set of pre-determined θ-coordinates. And, each ICSPEⱼₒ further includes an inner stator pole coil set (ISPCSⱼₒ) having inner stator coil interconnecting terminals (ISCITⱼₒ) and wound upon said ICSPEⱼₒ. At a phase according to the relative θ-coordinate between the RDUⱼ and its two neighboring stator units, each ISPCSⱼₒ is powered by an inner stator coil current (ISCCⱼₒ) via the ISCITⱼₒ. Corresponding to each ICRPEⱼₙ, low reluctance inner circumferential magnetic flux field (ICMFFⱼₙ) with low magnetic loss is excited by the powered ISPCSⱼₒ due to a local and short-path. A high component inner circumference switched reluctance torque (ISRTQⱼₖ) is produced while each ICRPEⱼₙ is passing each of the ICSPEⱼₒ. And a switched reluctance torque (SRTQⱼ) equal to 2*(SRTQⱼ₁+SRTQⱼ₂+ . . . +SRTQ_{jP})+(ISRTQⱼ₁+ISRTQⱼ₂+ . . . +ISRTQ_{jR}) is produced by the SSRMⱼ.

In a more specific embodiment, the MUMMS includes, in an Axial Flux architecture, the complimentary stator pole pair are arranged along the periphery of rotation. The two opposing stator poles are separated by the thickness of the rotor disk plus two stator-to-rotor pole gaps (as illustrated in FIG. 8), a similar Axial Flux SRM design. This type of Axial Flux configuration represents the shortest achievable magnetic flux path.

In order to deliver large magnetic flux between complementary stator poles, sufficiently large pole surface area needs to be provided. This will substantially increase the bulkiness and weight of the conventional Radial Flux SRM. The larger pole cross section area would also limit the total number of stator/rotor poles that could be instituted in a conventional Radial Flux SRM. That in turn would limit its ability to generate large torque and power. This is because the deliverable torque and power is directly proportional to the total number of stator/rotor poles and their radial distance from the rotation center. On the other hand, as the number of stator poles increases, the available space for stator winding is also constrained.

High performance from SRM is obtainable only via sophisticated control electronics that help compensate the non-linear behavior between the drive current (supplied to the stator coil) and the output torque. The nonlinearity is due to the intrinsic nature of changing reluctance when the rotor is moving into and out of the stator field. The availability of control electronics at reasonable cost will be key for SRM to gain broader foothold in motor drive applications.

The present invention is intended to address the above issues that associate with conventional Radial Flux SRM and to transform SRM as a practical choice for a broad range of applications, large or small, heavy duty or light duty with a cost/performance that no other electric motor could match.

This summary is provided to introduce a selection of inventive concepts in a simplified form that will be further described below under the detailed description. As such, this summary is not intended to delimit the scope of the claimed subject matter.

These aspects of the present invention and their numerous embodiments are further made apparent, in the remainder of the present description, to those of ordinary skill in the art.

### BRIEF DESCRIPTION OF THE DRAWINGS

In order to more fully describe numerous embodiments of the present invention, reference is made to the accompanying drawings. However, these drawings are not to be considered limitations in the scope of the invention, but are merely illustrative:

FIG. 1 is a cross sectional illustration of a prior art radial flux Switched Reluctance Motor (SRM) with a phase timing illustration.

FIG. 2 illustrates the concept of a multi-stackable axial field SRM with a cross sectional diagram of a triple-stackable axial field SRM under the present invention.

FIG. 3 illustrates the concept of the stator modules of a multi-stackable axial field SRM with a cross sectional diagram of the stator modules of a triple-stackable axial field SRM under the present invention.

FIG. 4 illustrates the concept of the rotor modules of a multi-stackable axial field SRM with a cross sectional diagram of the rotor modules of a triple-stackable axial field SRM under the present invention.

FIG. 5 illustrates the concept of a multi-stackable multi-drive axial field SRM with a cross sectional diagram of a triple-stackable twin-drive axial field SRM under the present invention.

FIG. 6 illustrates the concept of the stator modules of a multi-stackable multi-drive axial field SRM with a cross sectional diagram of the stator modules of a triple-stackable twin-drive axial field SRM under the present invention.

FIG. 7 illustrates the concept of the rotor modules of a multi-stackable multi-drive axial field SRM with a cross sectional diagram of the rotor modules of a triple-stackable twin-drive axial field SRM under the present invention.

FIG. 8 is a perspective illustration of the transverse magnetic field drive under the present invention. In an axial flux architecture, the complimentary stator pole pair are arranged along the periphery of rotation. The two opposing stator poles are separated by the thickness of the rotor disk plus two stator-to-rotor pole gaps as illustrated in FIG. 8, a similar Axial Flux SRM design. This type of Axial Flux configuration represents the shortest achievable magnetic flux path.

FIG. 9 is a perspective illustration of the tangential magnetic field drive under the present invention.

FIG. 10 illustrates the three-phase transverse magnetic field drive switching of a triple-stackable SRM with a perspective illustration of the three-phase transverse magnetic field drive switching of a triple-stackable SRM and its corresponding timing diagram under the present invention.

FIG. 11 is a perspective illustration of the energy recovery transformer of a transverse magnetic field drive and the energy recovery transformer of a tangential magnetic field drive under the present invention.

FIG. 12 is a perspective schematic illustration of a prior art SRM Switching Circuit.

FIG. 13 is a perspective schematic illustration of a reduced SRM Switching Circuit with use of energy recovery transformer under the present invention.

### DETAILED DESCRIPTION OF PREFERRED EMBODIMENTS

The description above and below plus the drawings contained herein merely focus on one or more currently preferred embodiments of the present invention and also describe some exemplary optional features and/or alternative embodiments. The description and drawings are presented for the purpose of illustration and, as such, are not limitations of the present invention. Thus, those of ordinary skill in the art would readily recognize variations, modifications, and alternatives. Such variations, modifications and alternatives should be understood to be also within the scope of the present invention.

For a first purpose of achieving high rotation torque density of a motor, the present invention provides a motor apparatus that is capable of shortening the paths of magnetic flux, extending the drive arm, and reducing the mass/volume of a rotor. For a second purpose of lowering the overall cost, the present invention provides a motor apparatus that is capable of minimizing use of materials and components and simplifying motor structure. For a third purpose of maximizing reliability and robustness, a forth purpose of increasing manufacturability, and a fifth purpose of easing inventory management, the present invention provides a motor apparatus that is capable of simplifying the motor design, configuration, customization, and manufacturing. And for maximized benefits and advanced motor features, the present invention takes full combined advantages of both SRM architecture and “Axial Flux” architecture by applying “Axial Flux” architecture into SRM design without using any permanent magnet, by modularizing and stacking the “Axial Flux” SRM design for easy configuration and customization to satisfy various drive torque requirements and broad applications, and by incorporating an en energy recovery transformer for minimizing switching circuitry thus further lowering the cost and further increasing the reliability and robustness. Unlike prior arts, the present invention does not use any permanent magnet and this “Axial Flux” SRM system is modularized and stackable with many benefits.

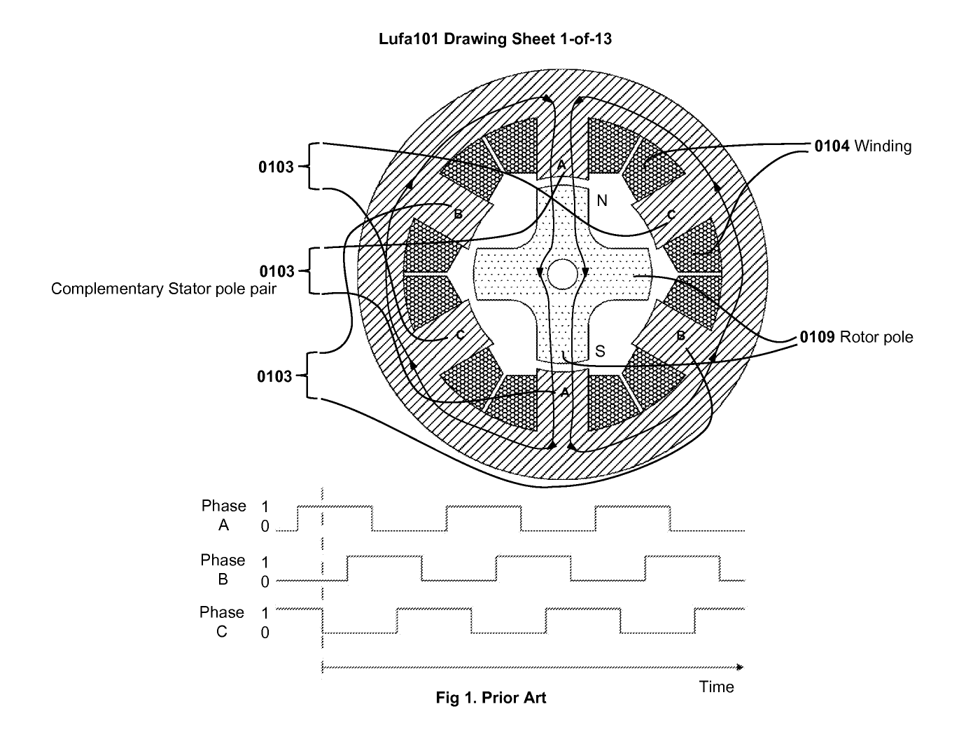

FIG. 1 is a cross sectional illustration of a prior art radial flux Switched Reluctance Motor (SRM) with a phase timing illustration. This SRM has a stator with six (6) stator poles or three (3) stator pole pairs 0103 and a rotor with four (4) rotor poles or two (2) rotor pole pairs 0109. Winding 0104 is surrounding each stator pole 0103 respectively. The windings 0104 are powered by power/current supplies driven by a switching circuit with timing diagram with Phase A, Phase B, and Phase C as shown in the figure and the motor operates accordingly.

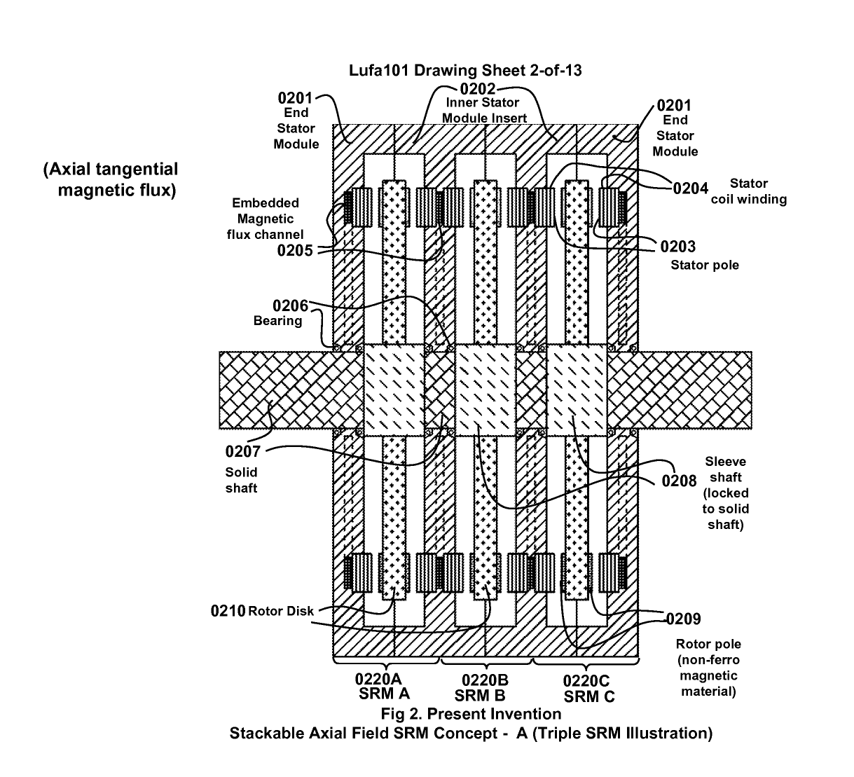

FIG. 2 illustrates the concept of a multi-stackable axial field SRM with a cross sectional diagram of a triple-stackable axial field SRM under the present invention. This SRM has a stator stacked with four (4) stator modules: two End Stator Modules 0201 at both ends along the solid shaft 0207 and two Inner Stator Module Inserts 0202. This SRM has a rotor consisting of a solid shaft 0207 that is locked to three (3) sleeve shafts 0208 and thus three functional units: SRM A 0220A, SRM B 0220B, and SRM C 0220C. Each sleeve shaft is locked to a rotor disk 0210 which is turned by magnetic forces between the stator poles 0203 and the rotor poles 0209. These forces are powered through an embedded magnetic flux channel 0205 exited by currents inside stator coil windings 0204 circumferential to stator poles 0203. The solid shaft 0207 then rotates driven by rotation of rotor disks with rotatable support from bearings 0206.

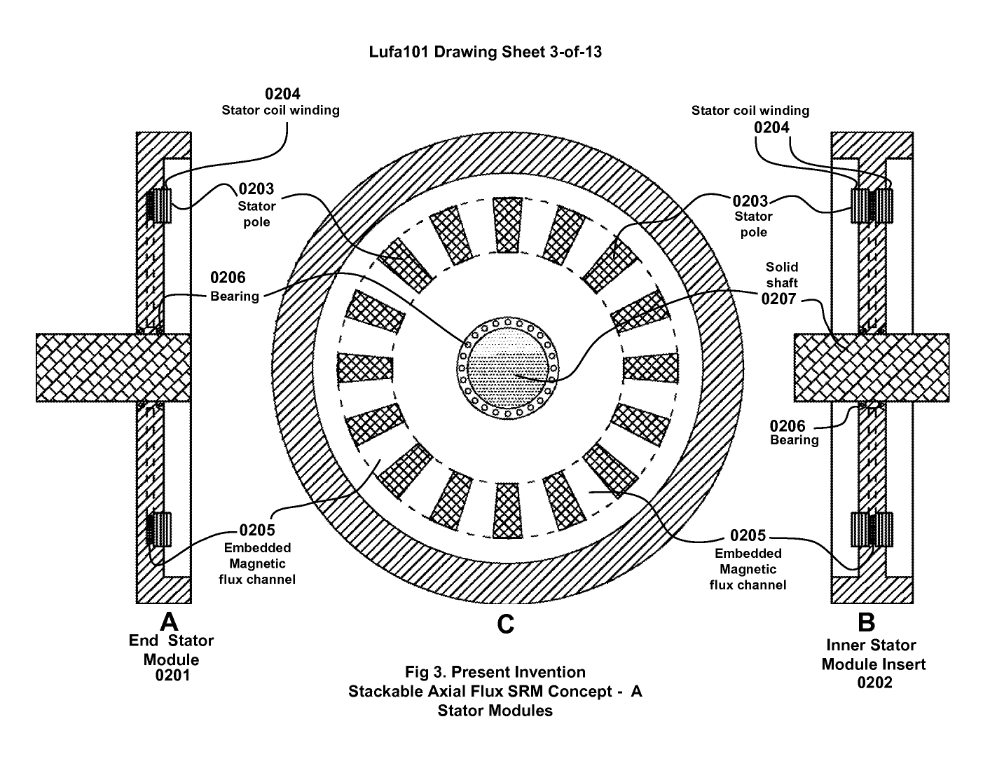

FIG. 3 illustrates the concept of the stator modules of a multi-stackable axial flux SRM with a cross sectional diagram of the end stator module 0201 and inner stator module insert 0202 of a triple-stackable axial flux SRM under the present invention. Magnetic forces are produced by powering stator coil winding 0204 circumferential to a stator poles 0203 generating magnetic flux through embedded magnetic flux channels. The rotor disk 0210, shown in FIG. 2, drives and rotates the solid shaft 0207 with the rotatable support of bearings 0206.

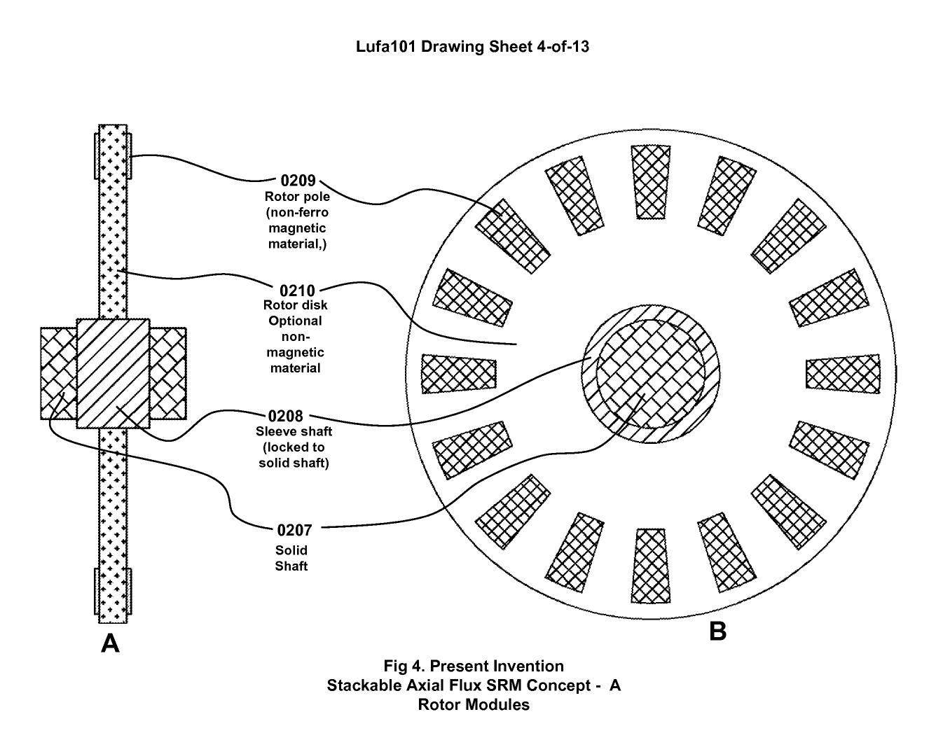

FIG. 4 illustrates the concept of the rotor modules of a multi-stackable axial field SRM with a cross sectional diagram of the rotor modules of a triple-stackable axial field SRM under the present invention. The solid shaft 0207 is locked to a sleeve shaft 0208, which is locked to a rotor disk 210. The rotor disk 0210 turns, due to magnetic forces between rotor poles 0209 and stator poles 0203 (FIG. 2), and rotates the sleeve shaft 0208 and solid shaft 0207.

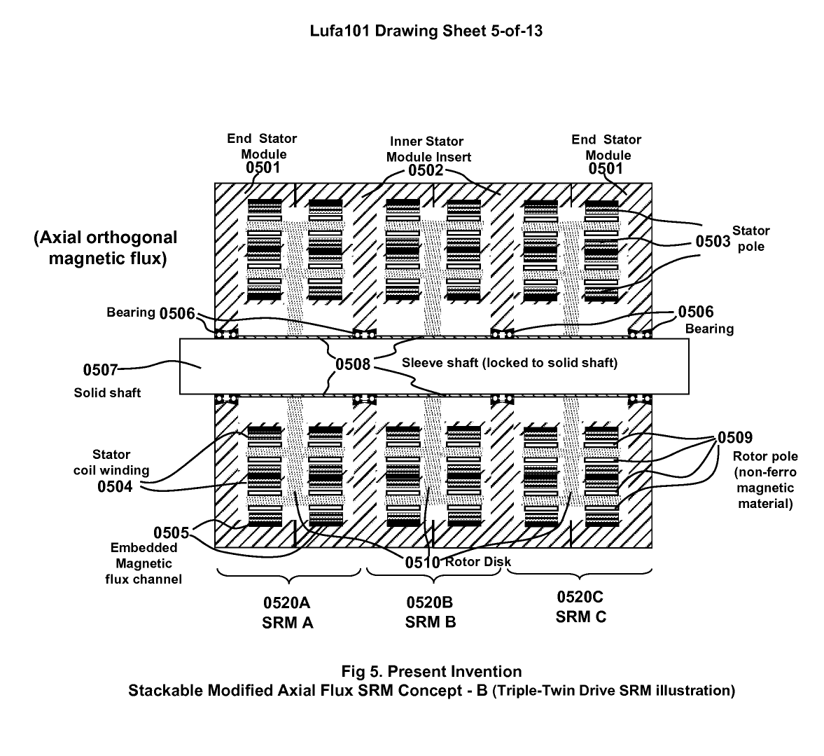

FIG. 5 illustrates the concept of a multi-stackable multi-drive axial field SRM with a cross sectional diagram of a triple-stackable twin-drive axial field SRM under the present invention. This SRM has a stator stacked with four (4) stator modules: two End Stator Modules 0501 at both ends along the solid shaft 0507 and two Inner Stator Module Inserts 0502. This SRM has a rotor consisting of a solid shaft 0507 that is locked to three (3) sleeve shafts 0508 and thus three functional units: SRM A 0520A, SRM B 0520B, and SRM C 0520C. Each sleeve shaft is locked to a rotor disk 0510 which is turned by magnetic forces between the stator poles 0503 and the rotor poles 0509. These forces are powered through an embedded magnetic flux channel 0505 by electric current inside stator coil windings 0504 circumferential around stator poles 0503. The solid shaft 0507 then rotates driven by rotor disks with the rotatable support of bearings 0506.

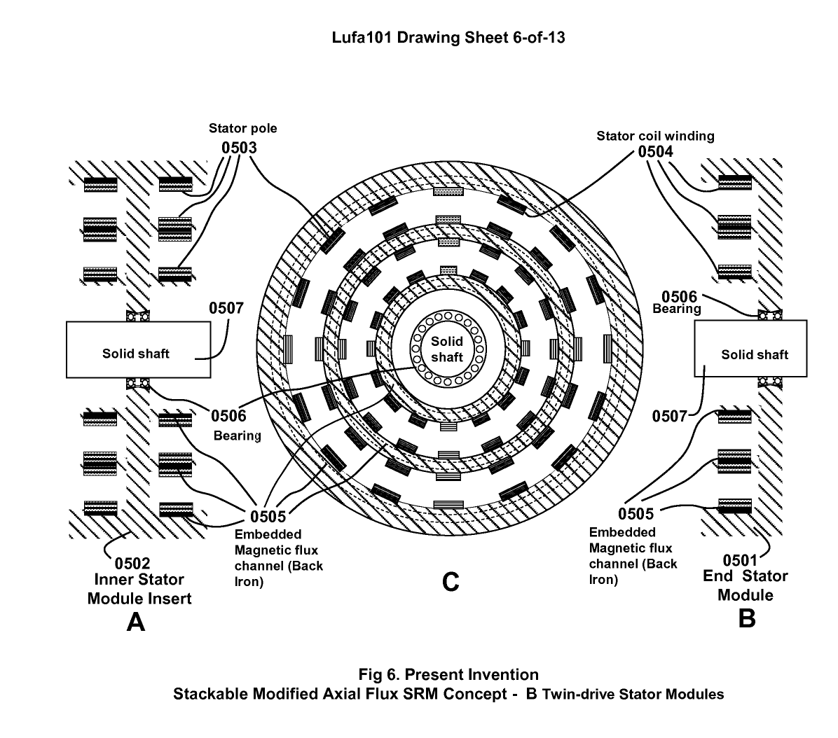

FIG. 6 illustrates the concept of the stator modules of a multi-stackable multi-drive axial flux SRM with a cross sectional diagram of an end stator module 0501 and an inner stator module insert 0502 of a triple-stackable twin-drive axial field SRM under the present invention. Magnetic forces are produced through an embedded magnetic flux channel 0505 by powering stator coil windings 0504 circumferential around stator poles 0503. The rotor disk 0510, shown in FIG. 5, rotates the solid shaft 0507 with rotatable support of bearings 0506.

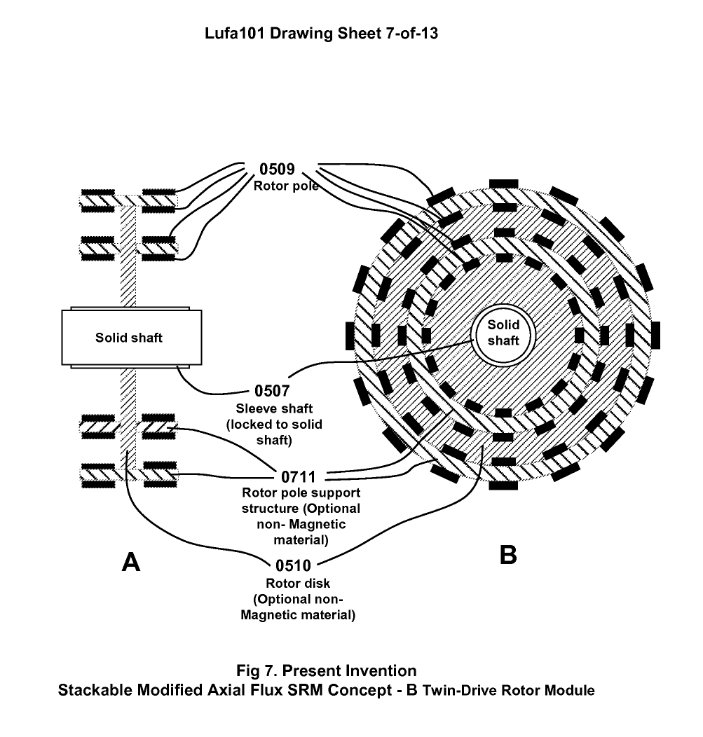

FIG. 7 illustrates the concept of the rotor modules of a multi-stackable multi-drive axial field SRM with a cross sectional diagram of the rotor modules of a triple-stackable twin-drive axial field SRM under the present invention. The solid shaft 0507 is locked to a sleeve shaft 0508, which is locked to a rotor disk 0510. The rotor disk 0510 turns, due to magnetic forces between rotor poles 0509 and stator poles 0503 (FIG. 5), and rotates the sleeve shaft 0508 and solid shaft 0507.

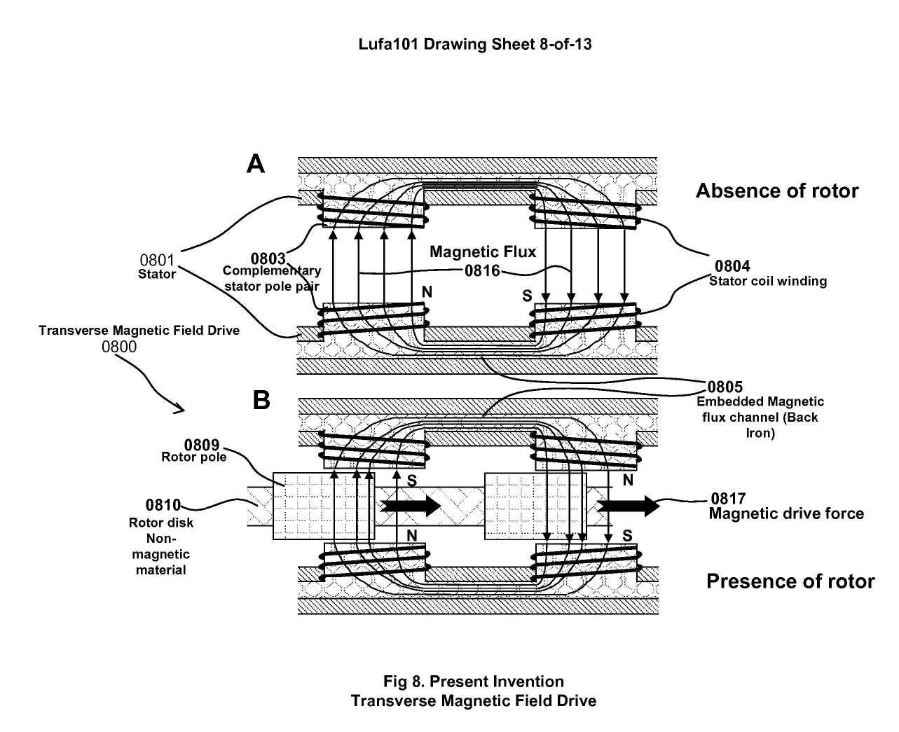

FIG. 8 is a perspective illustration of the transverse magnetic field drive under the present invention. In an Axial Flux architecture, the complimentary stator pole pair are arranged along the periphery of rotation. The two opposing stator poles are separated by the thickness of the rotor disk plus two stator-to-rotor pole gaps as illustrated in FIG. 8, a similar Axial Flux SRM design. This type of Axial Flux configuration represents the shortest achievable magnetic flux path.

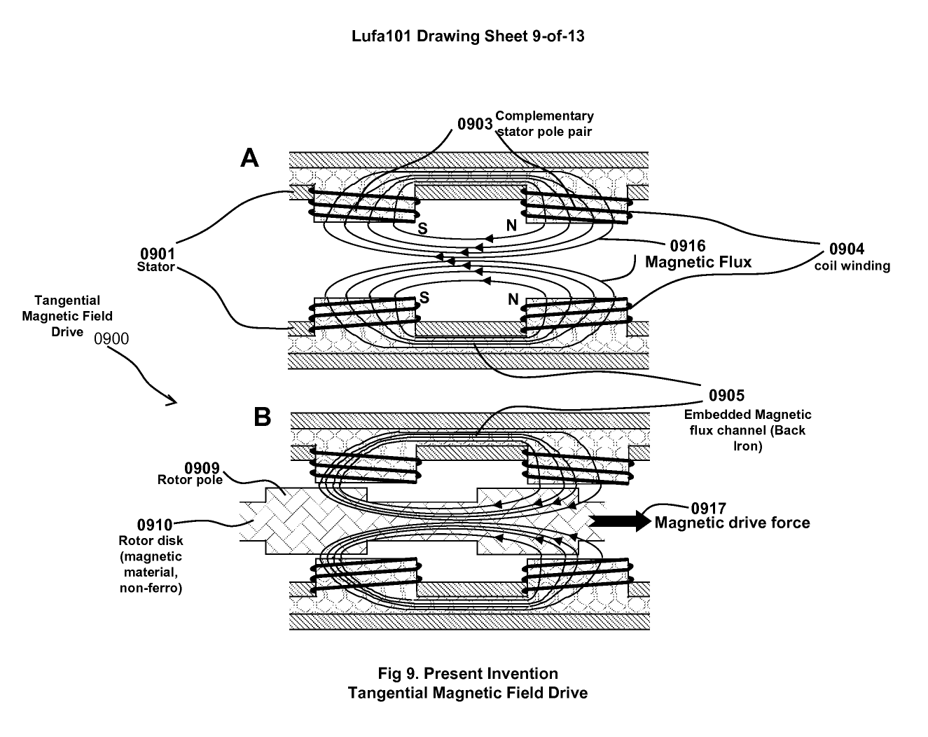

FIG. 9 is a perspective illustration of the tangential magnetic field drive under the present invention.

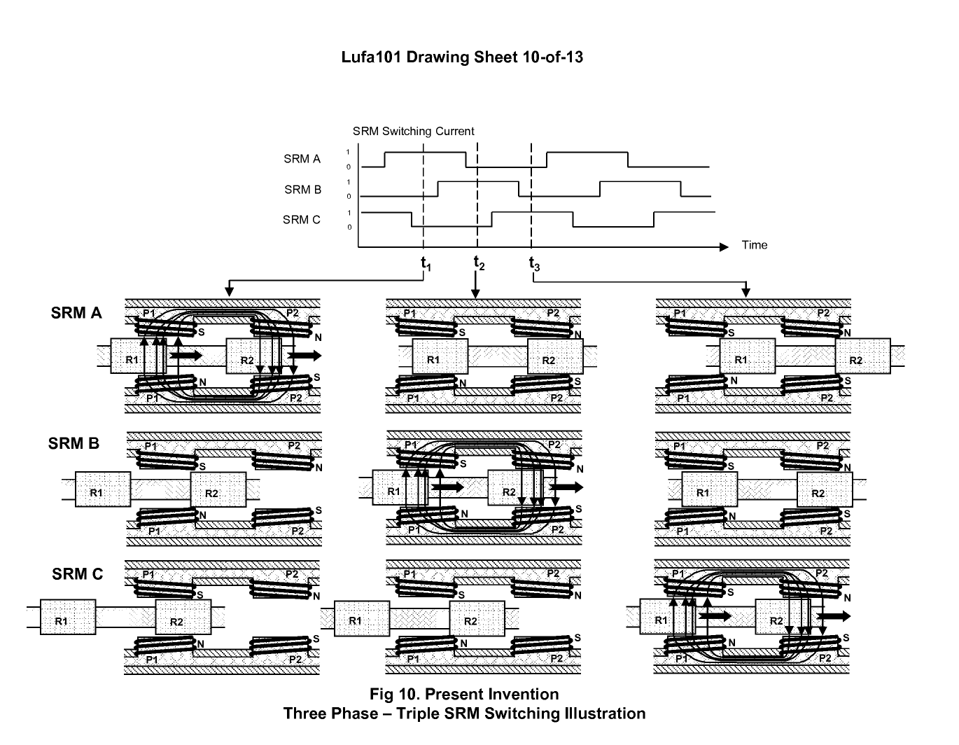

FIG. 10 illustrates the three-phase transverse magnetic field drive switching of a triple-stackable SRM with a perspective illustration of the three-phase transverse magnetic field drive switching of a triple-stackable SRM and its corresponding timing diagram under the present invention.

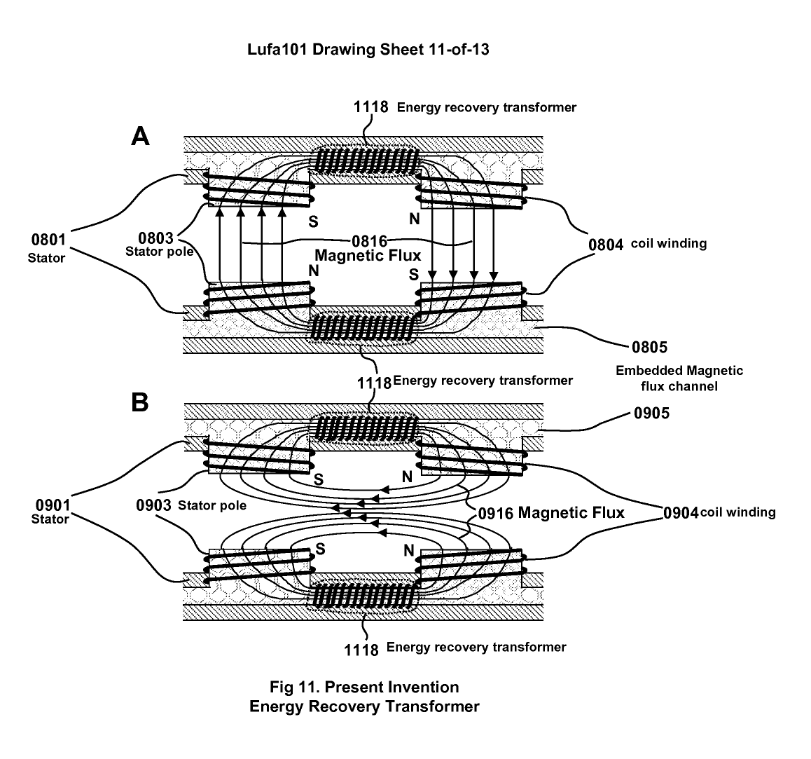

FIG. 11 is a perspective illustration of the energy recovery transformer of a transverse magnetic field drive and the energy recovery transformer of a tangential magnetic field drive under the present invention.

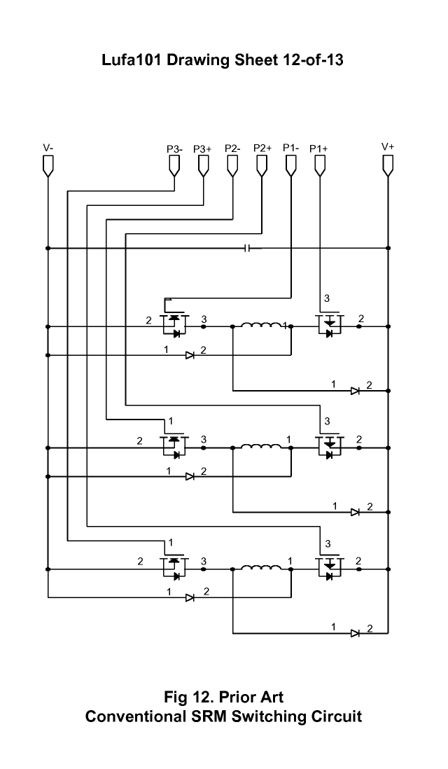

FIG. 12 is a perspective schematic illustration of a prior art SRM Switching Circuit.

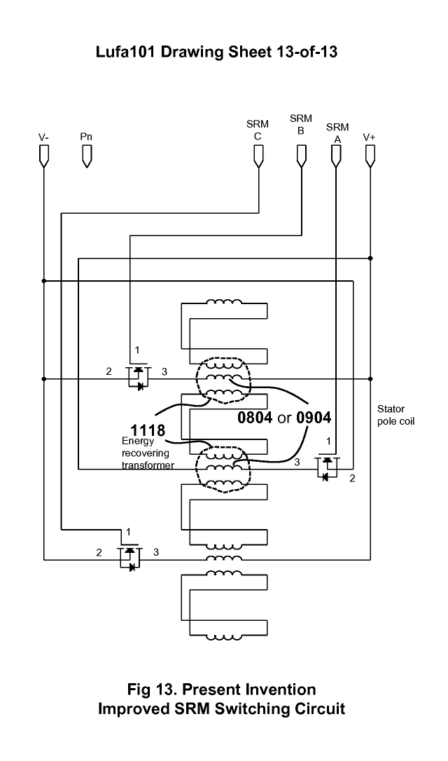

FIG. 13 is a perspective schematic illustration of a reduced SRM Switching Circuit with use of energy recovery transformer under the present invention.

Throughout the description and drawings, numerous exemplary embodiments were given with reference to specific configurations. It will be appreciated by those of ordinary skill in the art that the present invention can be embodied in numerous other specific forms and those of ordinary skill in the art would be able to practice such other embodiments without undue experimentation. The scope of the present invention, for the purpose of the present patent document, is hence not limited merely to the specific exemplary embodiments of the foregoing description, but rather is indicated by the following claims. Any and all modifications that come within the meaning and range of equivalents within the claims are intended to be considered as being embraced within the spirit and scope of the present invention.

We claim:

1. A multi-unit modular stackable motor system (MUMMS) for generating high torque density, defined as torque per unit motor volume or mass, through its rotor, the MUMMS comprises, expressed in a composite Cartesian and polar coordinate system r-θ-Z with the MUMMS rotor rotational plane parallel to r-θ plane:
A) a rotor shaft having a shaft core with a first shaft end and a second shaft end and oriented parallel to Z-axis; and
B) an N-module motor system (NMMS) comprising N stacked switched reluctance motor modules (SSRM₁, SSRM₂, . . . , SSRMⱼ, . . . , SSRM_{N} where N>=1), with each rotor unit independently lockable to the rotor shaft, all located along and coaxially coupled to the same rotor shaft as their common shaft of rotation,
whereby upon simultaneous powering of a selected subset of said (SSRM₁, . . . , SSRM_{N}) the MUMMS produces a total output torque that is the sum total of those produced by said selected subset.

2. The MUMMS of claim 1 wherein the NMMS comprises:
a first end stator unit (FESU) located upon the shaft core near the first shaft end, the FESU having a first end central bearing for rotatably supporting the shaft core there through;
a second end stator unit (SESU) located upon the shaft core near the second shaft end, the SESU having a second end central bearing for rotatably supporting the shaft core there through;
an intervening set of sequentially and mechanically locked rotor disk unit-1 (RDU₁), inner stator unit insert-1 (ISUI₁), rotor disk unit-2 (RDU₂), inner stator unit insert-2 (ISUI₂), . . . , rotor disk unit-j (RDUⱼ), inner stator unit insert-j (ISUIⱼ), . . . , rotor disk unit-N−1 (RDU_{N-1}), inner stator unit insert-N−1 (ISUI_{N-1}) and rotor disk unit-N (RDU_{N}), located upon the shaft core between the FESU and the SESU, for mechanically coupling the FESU to the SESU, wherein each ISUIⱼ having a central bearing-j (CBⱼ) for rotatably supporting the shaft core there through and each RDUⱼ having an integral central sleeve shaft-j (CSSⱼ) locked upon the shaft core; and
wherein each RDUⱼ and its two neighboring stator units respectively comprises a non-ferro magnetic rotor pole structure (RPSⱼ) and two magnetically energizable stator pole structures (SPSⱼ₋₁) & (SPSⱼ) confronting yet separated from the RPSⱼ by at least two air gaps (AGⱼ₋₁) & (AGⱼ) thus forming the SSRMⱼ.

3. The MUMMS of claim 2 wherein the shaft core comprises an adjustable shaft locking means and, correspondingly, each CSSⱼ comprises an adjustable sleeve locking means for mating then locking each CSSⱼ upon the adjustable shaft locking means with an adjustable relative θ-offset there between.

4. The MUMMS of claim 2 wherein:
each RPSⱼ comprises a plurality of circumferential rotor pole elements (CRPEⱼₖ, k=1,2, . . . , P where P>1) located near the RDUⱼ periphery and further distributed along θ-direction according to a first set of pre-determined θ-coordinates; and correspondingly,
each SPSⱼ comprises a plurality of circumferential stator pole elements (CSPEⱼₘ, m=1,2, . . . , Q where Q>1) located near the RDUⱼ periphery, further distributed along θ-direction according to a second set of pre-determined θ-coordinates and, each CSPEⱼₘ further comprising a stator pole coil set (SPCSⱼₘ) having stator coil interconnecting terminals (SCITⱼₘ) and wound upon said CSPEⱼₘ such that, upon powering of each SPCSⱼₘ with a stator coil current (SCCⱼₘ) via the SCITⱼₘ with a phase according to the relative θ-coordinate between the RDUⱼ and its two neighboring stator units,
1) corresponding to each CRPEⱼₖ a local, short-path thus low reluctance circumferential magnetic flux field (CMFFⱼₖ) with low magnetic loss can be successfully excited by the powered SPCSⱼₘ while said each CRPEⱼₖ passing through each of the CSPEⱼₘ thus producing a high component switched reluctance torque (SRTQⱼₖ); and
2) The SSRMⱼ produces a switched reluctance torque (SRTQⱼ) equal to SRTQⱼ₁+SRTQⱼ₂+ . . . +SRTQ_{jP}).

5. The MUMMS of claim 4 wherein:
said first set of pre-determined θ-coordinates are evenly distributed around 360 degrees; and
said second set of pre-determined θ-coordinates are evenly distributed around 360 degrees.

6. The MUMMS of claim 4 wherein:
each CRPEⱼₖ comprises two opposite elemental rotor pole faces (ERPFⱼₖ₁ and ERPFⱼₖ₂) both oriented perpendicular to Z-axis; and correspondingly,
each CSPEⱼₘ of ISUIⱼ comprises two opposing elemental stator pole faces (ESPFⱼₘ₁ and ESPFⱼₘ₂) both oriented perpendicular to Z-axis and, upon rotation of the RDUⱼ, successively surrounding each of the pair (ERPFⱼₖ₁, ERPFⱼₖ₂) while separating from it by two elemental air gaps EAGⱼ₁ and EAGⱼ₂ such that, under conditions of otherwise equal air gap flux density, rotor pole face area, stator pole face area and distance between air gap and the z-axis, the produced component SRTQⱼₖ is about twice as that produced by another system with a single elemental air gap.

7. The MUMMS of claim 6 wherein the SPCS_{j,m}, SPCS_{j,m+1} of each neighboring pair (CSPE_{j,m}, CSPE_{j,m+1}) along θ-coordinate are wound with coordinated direction such that, upon powering either one of SPCS_{j,m}, SPCS_{j,m+1} with a stator coil current, the so excited circumferential magnetic flux field has a single-loop pattern that:
d) has its primary plane oriented perpendicular to r-direction;
e) threads through two peripheral flux return yokes (PFRY_{j,m1}, PFRY_{j,m2}) respectively of the ISUIⱼ₋₁ and the ISUIⱼ; and
f) also sequentially threads through the (ESPF_{j,m1},ESPF_{j,m2},ESPF_{j,m+12},ESPF_{j,m+11}).

8. The MUMMS of claim 7 wherein the two (PFRY_{j,m1}, PFRY_{j,m2}) comprise at least one close-loop energy transfer coil (CLETCⱼₘ) wound thereon such that:
following a switching off of SCCⱼₘ but before a switching on of SCCⱼₘ₊₁ the magnetic energy stored in the circumferential magnetic flux field gets absorbed by a correspondingly generated current through the CLETCⱼₘ counter balancing out an otherwise would be generated detrimental electromagnetic motive force (EMF) across the SPCS_{j,m}; and
upon a later switching on of SCCⱼₘ₊₁ its stator coil current build up would cause a corresponding transfer of the previously absorbed energy from the CLETCⱼₘ to the SCCⱼₘ₊₁, whereby,
comparing with a traditional system without the close-loop energy transfer coil but having to use two external drive transistors per stator pole coil set, the MUMMS advantageously requires only one external drive transistor per stator pole coil set.

9. The MUMMS of claim 6 wherein the SPCS_{j,m}, SPCS_{j,m+1} of each neighboring pair (CSPE_{j,m}, CSPE_{j,m+1}) along θ-coordinate are wound with coordinated direction and further connected in series or parallel such that, upon their powering with SCCⱼₘ and SCCⱼₘ₊₁, the so excited CMFFⱼₘ has two tangentially reinforcing sub-loops:
d) both having its primary plane oriented perpendicular to r-direction;
e) respectively threading through two peripheral flux return yokes (PFRY_{j,m1}, PFRY_{j,m2}) respectively of the ISUIⱼ₋₁ and the ISUIⱼ; and
f) also respectively threading through the (ESPF_{j,m1},ESPF_{j,m+11}) and the (ESPF_{j,m2},ESPF_{j,m+12}).

10. The MUMMS of claim 9 wherein the PFRY_{j,m1} and PFRY_{j,m2} respectively comprises a close-loop energy transfer coil CLETC_{j,m} and a CLETC_{j-1,m} wound thereon such that:
following a switching off of SCCⱼₘ but before a switching on of SCC_{j,m+1} the magnetic energy stored in the circumferential magnetic flux field gets absorbed by two correspondingly generated current through CLETC_{j,m} and CLETC_{j-1,m} counter balancing out two otherwise would be generated detrimental electromagnetic motive forces (EMF) respectively across the SPCS_{j,m} and the SPCS_{j-1,m}; and
upon a later switching on of SCC_{j,m+1} its stator coil current build up would cause a corresponding transfer of the previously absorbed energy from the CLETC_{j,m} and the CLETC_{j-1,m} to the SCC_{j,m+1}, whereby,
comparing with a traditional system without the close-loop energy transfer coil but having to use two external drive transistors per stator pole coil set, the MUMMS advantageously requires only one external drive transistor per stator pole coil set.

11. The MUMMS of claim 4 wherein:
each CRPEⱼₖ comprises two opposite elemental rotor pole faces (ERPFⱼₖ₁ and ERPFⱼₖ₂) both oriented perpendicular to r-direction; and correspondingly,
each CSPEⱼₘ comprises two opposing elemental stator dipole faces (ESPFⱼₘ₁ and ESPFⱼₘ₂) both oriented perpendicular to r-direction and, upon rotation of the RDUⱼ, successively surrounding each of the pair (ERPFⱼₖ₁, ERPFⱼₖ₂) while separating from it by two elemental air gaps EAGⱼ₁ and EAGⱼ₂ such that, under conditions of otherwise equal air gap flux density, rotor pole face area, stator pole face area and distance between air gap and the z-axis, the produced component SRTQⱼₖ is about twice as that produced by another system with a single elemental air gap.

12. The MUMMS of claim 4 wherein:
each RPSⱼ further comprises a plurality of inner circumferential rotor pole elements (ICRPEⱼₙ, n=1,2, . . . , R where R>1) arranged concentric with but located closer to the rotor shaft with respect to the plurality of CRPEⱼₖ, and further distributed along θ-direction according to a third set of pre-determined θ-coordinates; and correspondingly,
each SPSⱼ comprises a plurality of inner circumferential stator pole elements (ICSPEⱼₒ, o=1,2, . . . , S where S>1) arranged concentric with but located closer to the rotor shaft with respect to the plurality of CSPEⱼₘ, and further distributed along θ-direction according to a fourth set of pre-determined θ-coordinates and, each ICSPEⱼₒ further comprises an inner stator pole coil set (ISPCSⱼₒ) having inner stator coil interconnecting terminals (ISCITⱼₒ) and wound upon said ICSPEⱼₒ such that, upon powering of each ISPCSⱼₒ with an inner stator coil current (ISCCⱼₒ) via the ISCITⱼₒ with a phase according to the relative θ-coordinate between the RDUⱼ and its two neighboring stator units,
3) corresponding to each ICRPEⱼₙ a local, short-path thus low reluctance inner circumferential magnetic flux field (ICMFFⱼₙ) with low magnetic loss can be successfully excited by the powered ISPCSⱼₒ while said each ICRPEⱼₙ passing each of the ICSPEⱼₒ thus producing a high component inner circumference switched reluctance torque (ISRTQⱼₖ); and
4) The SSRMⱼ produces a switched reluctance torque (SRTQⱼ) equal to 2*(SRTQⱼ₁+SRTQⱼ₂+ . . . +SRTQ_{jP})+(ISRTQⱼ₁+ISRTQⱼ₂+ . . . +ISRTQ_{jR}).

13. The MUMMS of claim 12 wherein:
said third set of pre-determined θ-coordinates are evenly distributed around 360 degrees; and
said fourth set of pre-determined θ-coordinates are evenly distributed around 360 degrees.

14. The MUMMS of claim 4 wherein P=Q.

15. The MUMMS of claim 12 wherein R=S.
